(19) United States
(12) Patent Application Publication
(10) Pub. No.: US 2003/0021502 A1
(43) Pub. Date: Jan. 30, 2003

(54) High performance wear bearing insert

(76) Inventors: Jay Thomas Duke, West Jordan, UT (US); Bruce J. Downard, Stansbury Park, UT (US)

Correspondence Address: Laurence C. Begin, Dinnin & Dunn, P.C., 755 W. Big Beaver Rd., Troy, MI, 48084, US

(21) Appl. No.: 09/925,052

(22) Filed: Aug. 8, 2001

Related U.S. Application Data
(60) Provisional application No. 60/223,772, filed on Aug. 8, 2000.

(51) Int. Cl. F16C 29/02

(52) U.S. Cl. 384/32

(57) ABSTRACT

The instant invention includes a two-piece interlocking wear bearing insert 10. The wear bearing insert 10 of the instant invention utilizes a complementary two-piece design that prevents rotation of the entire assembly in a groove 16 of one reciprocating element. A plurality of lubrication slots 28 and 38 in a respective axial edge of each interlocking element 20 and 40 facilitates even distribution of lubricants. Slots 28 and 38 may be molded into the interlocking elements 20 and 40, thereby obviating the need to machine holes into the wear bearing insert 10 material. Each element 20 and 40 contains an axial slot 26 and 46, respectively, wherein each slot axially extends through a relatively narrow or cylindrically short section 24 and 44, respectively, of each element 20 and 40, respectively. Known designs contain axial slots that axially extend across the length of the bearing surface thereby increasing the likelihood of bearing insert failure given an associated reduction in the bearing surface area. The axial slots 26 and 46 formed in the narrow arcuate sections 24 and 44 do not extend through the length of the entire assembly 10 and therefore reduce insert 10 failure when the complementary elements 20 and 40 are nested together as a unit 10.

### CROSS-REFERENCE TO RELATED APPLICATIONS

The present application claims the benefit of U.S. Provisional Application Serial No. 60/223,772 filed on Aug. 8, 2000.

### BACKGROUND OF THE INVENTION

Wear bearing inserts are often used as buffering elements between primary structural elements of reciprocating actuators such as pistons, rods, and housings. Wear bearing inserts are sometimes comprised of sacrificial material having lubrication holes therein to facilitate the penetration of friction-reducing lubricants. Known in the art wear bearing inserts are typically annular, having an axial gap cut through the annulus to provide for thermal expansion, fluid swell, and manufacturing tolerances of the primary elements.

Prior art wear bearing inserts are subject to failure when the axial gap therein is aligned with an area of peak load between the reciprocating elements. Given that the width of the gap extends across the entire bearing surface, the gap or axial slot significantly reduces the bearing surface thereby resulting in bearing failure. Additionally, the machining of lubricant holes into existing wear bearing inserts is costly and time consuming.

### SUMMARY OF THE INVENTION

The instant invention overcomes the aforementioned problems by providing a two-piece interlocking wear bearing insert. The wear bearing insert of the instant invention utilizes a complementary two-piece design that prevents rotation of the entire assembly in a groove of one reciprocating element. A plurality of lubrication slots in an axial edge of each interlocking element facilitates even distribution of lubricants. These slots may be molded into the interlocking elements, thereby obviating the need to machine holes into the wear bearing insert material.

Stated another way, the wear bearing insert contains two interlocking elements of equivalent circumference joined in inverted nested relationship. Each element contains a wide or relatively cylindrically long section and a narrow or relatively cylindrically short section. Each element contains an axial slot wherein each slot axially extends through the relatively narrow or cylindrically short section of each element, respectively. In contrast, known designs contain axial slots that axially extend across the length of the bearing surface thereby increasing the likelihood of bearing insert failure given an associated reduction in the bearing surface area. The axial slots formed in the narrow arcuate sections do not extend through the length of the entire assembly and therefore reduce insert failure when the complementary elements are nested together as a unit.

The instant invention provides an axial slot in each interlocking element that does not extend through the length of the entire assembly when the complementary elements are nested together, thereby reducing failure of the insert due to the loss of effective bearing surface area. Additional advantages and features of the instant invention will become apparent from the detailed description included hereinbelow, in conjunction with the accompanying drawing Figures.

### BRIEF DESCRIPTION OF THE DRAWINGS

FIG. 1 is a cross-sectional view of the environment of the instant invention illustrating the primary structural elements cooperating with a wear bearing insert.

FIG. 2a is an isometric view of the wear bearing insert of the instant invention illustrating interlocking rings.

FIG. 2b is an isometric view of the wear bearing insert assembly of the instant invention illustrating interlocking rings and that the gap in the bearing surface is reduced in size and not concentrated in one area.

FIG. 2c is an isometric view of an alterative embodiment of the instant invention showing lubrication holes molded into the bearing surface with simple tooling.

FIG. 3 is a top view of a wear bearing insert in accordance with the instant invention illustrating a partial loss of the bearing surface due to the gap extending across a longitudinal surface of the bearing.

FIG. 4 is an isometric view of a prior art wear bearing assembly illustrating a conventional bearing gap through the entire bearing surface.

### DESCRIPTION OF THE INVENTION

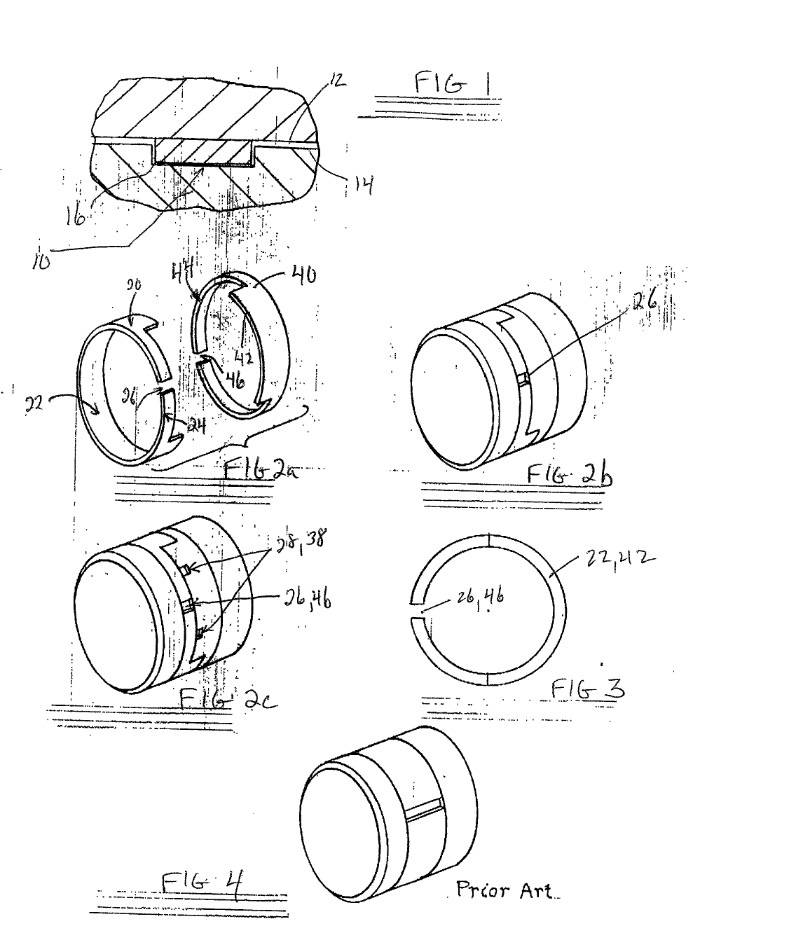

As shown in FIGS. 1, 2a, 2b, and 2c, a wear bearing insert 10 for relatively displaceable machine parts 12 and 14, is disposed in a groove 16 machined into a one of the relatively displaceable parts. The bearing insert 10 comprises a pair of opposed nesting annular elements 20 and 40. Each annular element is comprised of a wide arcuate section 22 and 42 respectively, and a narrow arcuate section 24 and 44. The narrow arcuate section 24 and 44 of each annular element further has an axial slot 26 and 46 therein.

As best seen in FIG. 2c, each annular element 20 and 40 may have a plurality of axial lubrication slots, 28 and 38 respectively, disposed in the wide arcuate sections 22 and 42 thereof. The lubrication slots 28 and 38 permit ready distribution of lubricants to the wear bearing assembly 10.

The annular elements 20 and 40 are oriented such that the wide arcuate section of one element nests with the narrow section of the opposed complementary element. As seen in FIG. 2b, this nesting arrangement of complementary elements provides for a reduced axial gap area when compared with prior art devices. Additionally, the axial gap of the instant invention does not extend through the entire assembly 10, as the wide arcuate section of the complementary element contacts the axial slot of the opposed element.

The nested elements 20 and 40, and thus the insert 10, may be molded from polymeric materials such as polyimide or acetal materials, or, they may be made from other materials well known for use as bearing inserts.

Although the preferred embodiments of the instant invention have been disclosed in detail, it will be appreciated by one of ordinary skill in the art that the various structural and operational features herein disclosed are susceptible to modification without departing from the scope of the invention disclosed herein.

We claim:

1. A wear bearing insert comprising:
a first annular element of a predetermined circumference comprising a wide first arcuate section, a narrow second arcuate section, and a first axial slot formed in the narrow second arcuate section along an associated length; and
a second annular element of a predetermined circumference equivalent to that of the first annular element, the second annular element comprising a wide third arcuate section, a narrow fourth arcuate section, and a second axial slot formed in the narrow fourth arcuate section along an associated length,
wherein the first arcuate section and the second arcuate section are joined in inverted nested relationship with the fourth arcuate section and the third arcuate section, respectively.

2. The wear bearing insert of claim 1 further comprising a plurality of lubrication channels radially extending through said first and third arcuate sections, said channels molded in said first and third sections.
